(19) United States
(12) Patent Application Publication
(10) Pub. No.: US 2010/0112439 A1
(43) Pub. Date: May 6, 2010

(54) TREATED ACTIVE MATERIAL, METHOD FOR TREATING THEREOF, AND PASTE CONTAINING THE TREATED ACTIVE MATERIAL

(76) Inventors: Ryuta Morishima, Aichi-ken (JP); Akira Kuroda, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/532,188

(22) PCT Filed: Mar. 21, 2008
(86) PCT No.: PCT/JP2008/055992

§ 371 Date: Sep. 21, 2009

(30) Foreign Application Priority Data
Mar. 26, 2007 (JP) 2007 079864

(51) Int. Cl. H01M 4/02; H01M 4/04; B29B 7/72

(52) U.S. Cl. 429/212; 366/76.2

(57) ABSTRACT

At least one organic molecular chain is strongly bonded to a surface of active material. By using a treated active material in which at least one organic molecular chain is strongly bonded to a surface of active material, it is possible to maintain a charge-discharge characteristic of a secondary battery or the like at a good level over a long period. A treated material 1 is obtained by chemically adsorbing organic molecular chains 5 onto a surface of active material 3. A bonding force between the active mass 3 and organic molecular chains 5 is 40-400 kJ/mol. In a case where the bonding force between the active material 3 and organic molecular chains 5 is 40-400 kJ/mol, when the treated active material 1 is used as an electrode active material of a secondary battery or the like, the charge-discharge characteristic of the secondary battery can be maintained at a good level over a long period.

The present application claims priority based on Japanese Patent Application No. 2007-079864 filed on Mar. 26, 2007. The entire contents of the application are incorporated herein by reference.

### TECHNICAL FIELD

The present invention relates to a treated active material obtained by treating an active material and to a method for treating the active material, and more particularly to a treated active material for use in secondary batteries and a method for treating the active material for the secondary batteries. The present invention also relates to a paste containing the treated active material and a method for manufacturing the paste.

### BACKGROUND ART

A technique is known for manufacturing battery electrodes by kneading an active material, water, and organic molecular chains to prepare an active material slurry and coating the obtained active material slurry on a collector surface.

According to the technique disclosed in Japanese Laid-Open Patent Application No. 2004-273424, an active material slurry is prepared by kneading a negative electrode active material, water, and organic molecular chains (in Japanese Laid-Open Patent Application No. 2004-273424, it is called an organic substance having a thickening effect). The active material slurry with a maximum dispersed particle size of 50 μm or less (the particle size of the active material slurry is measured using a grain gauge method) is used. By using the active material slurry with the maximum dispersed particle size of 50 μm or less, the occurrence of variations in the density of current flowing in the electrode when the active material slurry is coated on a collector surface to manufacture an electrode for a secondary battery is prevented.

According to the technique disclosed in Japanese Laid-Open Patent Application No. 2005-129482, an active material slurry is prepared by kneading an active material, water, water-soluble cellulose, and a rubber binder. According to the technique disclosed in Japanese Laid-Open Patent Application No. 2005-129482, a first slurry is prepared by mixing the active material, water, and water-soluble cellulose. Then, a second slurry is manufactured by admixing the rubber binder to the first slurry. An electrode for a secondary battery is manufactured by coating the second slurry on a collector surface. When the first slurry is prepared by mixing, the active material is pressed against the inner wall of a container, preventing it from aggregating within the first slurry.

In secondary batteries, a charge-discharge characteristic is sometimes degraded in repeated charging and discharging. This is because an active material peels off from a collector surface in repeated charging and discharging. As described in Japanese Laid-Open Patent Application No. 2004-273424, the variations in the density of electric current flowing in the electrode are inhibited, and such peeling of the active material from the collector surface can be expected to be inhibited by reducing the maximum dispersed particle size to 50 μm or less. However, with the technique described in Japanese Laid-Open Patent Application No. 2004-273424, because the bonding force between the active material and organic molecular chains is small, the active material inevitably peels off from the collector surface in repeated charging and discharging. Likewise, with the technique described in Japanese Laid-Open Patent Application No. 2005-129482, because the bonding force between the active material and water-soluble cellulose is also weak, the active material inevitably peels off from the collector surface.

With the conventional technique, the active material and organic molecular chains are attracted by the van der Waals force. The bonding force of the van der Waals force is 10 kJ/mol or less. In the case where the first slurry is mixed, while being pressed against the inner wall of the container, as described in Japanese Laid-Open Patent Application No. 2005-129482, the organic molecular chains (in this case, water-soluble cellulose) is strongly pressed against the active material within the first slurry. However, the bonding force between the active material and organic molecular chains cannot be increased. While the first slurry is prepared, the amount of water is determined such that it enables the final slurry (second slurry) to have flowability sufficient to coat the slurry on the collector surface. Therefore, although the active material and organic molecular chains are bonded, this bonding is due only to the action of van der Waals force.

In accordance with the present invention, a treated active material is obtained in which at least one organic molecular chain is strongly bonded to a surface of an active material. In accordance with the present invention, a paste containing the treated active material is provided. In accordance with the present invention, a secondary battery using the treated active material is provided. Further, in accordance with the present invention, a method for treating an active material, a method for manufacturing a paste, and an apparatus for manufacturing a paste are provided. A secondary battery manufactured using the treated active material in accordance with the present invention does not exhibit the characteristic of the treated active material peeling off from the collector surface even in repeated charging and discharging. Further, when a secondary battery is manufactured using the treated active material, a good charge-discharge characteristic of the secondary battery can be maintained over a long period.

### DISCLOSURE OF INVENTION

In a treated active material in accordance with the present invention, at least one organic molecular chain is chemically adsorbed onto a surface of active material.

In the treated active material, the active material and at least one organic molecular chain are strongly bonded. Because the active material and the organic molecular chain are difficult to separate when the treated active material is coated on a collector surface, the active material is difficult to peel off from the collector surface. This phenomenon occurs because the organic molecular chain is chemically adsorbed onto the surface of active material. The bonding force of chemical adsorption is as high as 40 to 400 kJ/mol, substantially higher than the van der Waals force. The van der Waals force is equal to or less than 10 kJ/mol. Thus, in the treated active material in accordance with the present invention, because the organic molecular chain is chemically adsorbed onto the active material surface, the active material and the organic molecular chain cannot be easily separated. Because the organic molecular chains are intertwined on the collector surface, the peeling of the active material from the electrode body can be inhibited.

A paste in accordance with the present invention contains an active material, a solvent, a binder, and at least one organic molecular chain having an SP value within a range of ±10 with respect to the SP value of the binder, and the organic molecular chain is chemically adsorbed onto the surface of active material.

Because the organic molecular chain having the SP value within the range of ±10 with respect to the SP value of the binder is used in such a paste, the affinity of the binder and organic molecular chain is high. Thus, the binder is easily dispersed in the paste. Where such paste is coated on a collector surface, the active material cannot easily peel from the collector surface. This is because the binder and organic molecular chain are thoroughly mixed and the organic molecular chain is strongly bonded to the active material. The term binder as used herein refers to a material having a property of increasing adhesion between surfaces of active material in contact, increasing adhesion between the active material and the collector surface, increasing adhesion between organic molecular chains, and increasing adhesion between the organic molecular chain and the collector surface.

The SP value will be described below. The SP value stands for a solubility parameter value and is used as an index of substance solubility. Substances with close SP values tend to be easily miscible, and the miscibility of a solute and a solvent can be determined by this value. The SP value can be obtained by computations. Thus, the SP value δ can be represented by the following Formula (4), where ΔH stands for a molar evaporation heat of the substance and V stands for a molar volume thereof

δ=((ΔH/V)−(R×T))^{1/2} (4)

Here R stands for a gas constant and T for temperature.

Thus, when choosing the type of binder, whether the SP value of the organic molecular chain is within the range of ±10 with respect to the SP value of the binder can be determined by calculating the SP value of the organic molecular chain by Formula (4).

A secondary battery in accordance with the present invention uses a treated active material in which at least one organic molecular chain is chemically adsorbed onto a surface of active material.

In the above secondary battery, a good charge-discharge characteristic can be maintained over a long period. This is because the treated active material cannot be easily peeled off from the collector surface even in repeated charging and discharging. For example, even in lithium ion secondary batteries in which a high-density current flows, by using the treated active material it is possible to maintain a good charge-discharge characteristic over a long period.

The present invention also provides a method for treating an active material. With the treatment method, a mixture containing the active material, at least one organic molecular chain, and a solvent are kneaded under conditions such that the value N is calculated by the following Formula (1):

N=100/(1+(1/Dt−1/Dr)×Ds) (1)

and the concentration of solids A in the mixture satisfies the following relationship (2):

N−10≦A≦N (2)

where Dt stands for a tap density of the active material, Dr stands for a true density of the active material, and Ds stands for a density of the solvent.

With the above-described treatment method, the organic molecular chain can be caused to be chemically adsorbed onto the surface of active material. Thus, a treated active material in which at least one organic molecular chain is chemically adsorbed onto the surface of active material can be obtained. Formula (1) presented hereinabove will be described below.

Where W stands for a mass of the active material, Dt stands for a tap density of the active material, Dr stands for a true density of the active material, and Ds stands for a density of the solvent. A volume V1 obtained when the treated active material of mass W is tapped and loaded can be represented by the following Formula (5).

V1=W/Dt (5)

A volume V2 actually occupied by the treated active material in the space where the treated active material is tapped can be represented by the following Formula (6).

V2=W/Dr (6)

From Formula (5) and Formula (6), a volume V3 in which no active material is present (that is, the gaps between particles of active material) in the space into which the active material has been loaded by tapping can be represented by the following Formula (7).

V3=V1−V2=(W/Dt)−(W/Dr) (7)

When the entire volume V3 is occupied by the solvent, the concentration of solids (mass of the active material divided by the sum of the mass of the active material and the mass of the solvent) N can be represented by the following Formula (8).

N=W/(W+(V3×Ds))×100 (8)

The above-described Formula (1) can be obtained by substituting Formulas (5), (6), (7) into Formula (8).

In the case where the concentration of solids is higher than the N value, the solvent is not present in some of the gaps between the particles of active material. There are zones in which dry particles of active material are in contact with each other.

In the case where the concentration of solids is less than the N value, the active material is not sufficiently loaded. The portions of active material are separated from each other in the solvent.

In the case where the concentration of solids is equal to the N value, all the gaps between the particles of active material are occupied by the solvent, and the particles of active material are in contact with each other, rather than being separated.

In pastes for electrodes, the mass of organic molecular chains is typically much less than that of active material. Thus, the concentration of solids A ((mass of active material+mass of organic molecular chain)/(mass of active material+mass of organic molecular chains+mass of solvent) in a mixture containing the active material, organic molecular chain, and solvent can be assumed to be substantially equal to the concentration of solids ((mass of active material)/(mass of active material+mass of solvent)) of the mixture containing the active material and solvent.

Where the concentration of solids A is equal to the N value, the solvent occupies all the gaps between the portions of active material, between the organic molecular chains, and between the active material and organic molecular chain, and the particles of active material are not separated.

In the case where the concentration of solids A is larger than the N value, the solvent is not present in some of the gaps between the portions of active material, gaps between the organic molecular chains, and gaps between the active material and the organic molecular chain.

In the case where the concentration of solids A is less than the N value, the active material and organic molecular chain are free in the solvent.

The research conducted by the inventors demonstrated that the organic molecular chain can be bonded to the surface of active material by the largest force when the concentration of solids A is equal to the N value. Thus, the organic molecular chain can be chemically adsorbed on the surface of active material. In the case where the concentration of solids A is larger than the N value, a state is assumed in which the solvent is not present on the surface of some portions of active material, and the organic molecular chain cannot be chemically adsorbed onto the surface of active material. Further, in the case where the concentration of solids A is too small in comparison with the N value, the flowability of the mixture becomes too high. As a result, the organic molecular chain cannot be adsorbed onto the surface of active material even when the mixture is kneaded. The research conducted by the inventors also demonstrated that the organic molecular chain cannot be adsorbed onto the surface of active material if the concentration of solids A is less than (N−10). It was confirmed that the organic molecular chain is adsorbed on the surface of active material if the mixture is kneaded under conditions such that Formula (2) is satisfied.

The present invention also provides another method for treating an active material.

This treatment method includes a step of kneading a mixture containing an active material and at least one organic molecular chain while continuously adding a solvent, detecting a point in time at which the force required for kneading the mixture has reached a maximum magnitude, a step of adding a predetermined amount of solvent to the mixture at this point in time, and further kneading the mixture.

With the above-described treatment method, the organic molecular chain can be chemically adsorbed onto the surface of active material, while reducing the force that kneads the mixture containing the active material, organic molecular chain, and solvent. The organic molecular chain can be reliably adsorbed onto the surface of active material if the mixture is kneaded at a point in time at which the force required for kneading the mixture is at a maximum, but the energy required for kneading increases. According to the above-described treatment method, the energy required for kneading can be decreased because a predetermined amount of solvent is added to the mixture at a point in time at which the force required for kneading the mixture is at a maximum.

With the above-described treatment method, the point in time at which the force required for kneading the mixture containing the active material, the organic molecular chain, and solvent is at a maximum is actually measured. Thus, even when the amount of solvent necessary to obtain a maximum force required for kneading the mixture differs depending on the type of active material and the type of organic molecular chain, the point in time at which the force required for kneading the mixture is at a maximum can be accurately determined. Further, with the above-described treatment method, other materials may be admixed in addition to the active material, the organic molecular chain, and solvent, and in this case, too, the point in time at which the force required for kneading the mixture is at a maximum can be accurately determined.

The present invention provides yet another method for treating an active material.

This treatment method includes a step of kneading a mixture containing an active material and at least one organic molecular chain, while continuously adding a solvent; detecting a point in time at which the force required for kneading the mixture switches from a rising trend to a falling trend and decreases to a predetermined force; a step of stopping the supply of the solvent when this point in time is detected; and further kneading the mixture.

With this treatment method, the organic molecular chain can also be chemically adsorbed onto the surface of active material, while reducing the force that kneads the mixture containing the active material, the organic molecular chain, and solvent. When kneading is performed while adding the solvent, the force required for kneading increases gradually; and when the gaps in the mixture are completely filled with the solvent, the force required for kneading is at a maximum. When the solvent is further added after the force required for kneading has assumed a maximum value, the force required for kneading decreases. This is because the concentration of solids decreases with the increase in the amount of solvent in the mixture.

With this treatment method, the supply of solvent is stopped at a point in time at which the force required for kneading the mixture switches from a rising trend to a falling trend and decreases to a predetermined force. By setting the predetermined force to a force at which the organic molecular chain can be chemically adsorbed by the surface of active material, it is possible to decrease the energy required for kneading. With the above-described treatment method, other materials may be admixed in addition to the active material, the organic molecular chain, and solvent, and in this case, too, the organic molecular chain can be chemically adsorbed onto the surface of active material.

The present invention provides still another method for treating an active material.

This treatment method includes a step of kneading a mixture containing an active material and at least one organic molecular chain, while continuously adding a solvent; detecting a point in time at which the temperature of the mixture during kneading switches from a rising trend to a falling trend and decreases to a predetermined temperature; a step of stopping the supply of the solvent when this point in time is detected; and further kneading the mixture.

With this treatment method, the organic molecular chain can also be chemically adsorbed onto the surface of active material, while reducing the force that kneads the mixture containing the active material, the organic molecular chain, and solvent. There is a proportional relationship between the force required to knead the mixture and the mixture temperature. This is because when the energy supplied to the mixture is high, the mixture accumulates thermal energy. Thus, the predetermined temperature may be set to a temperature at which the organic molecular chain can be chemically adsorbed onto the surface of active material. The force required to knead the mixture is not directly related to the state of the mixture and can vary depending on the state of the apparatus kneading the mixture, and the like. With the above-described treatment method, the state of the mixture can be directly monitored. Therefore, the organic molecular chain can be chemically adsorbed onto the surface of active material with higher accuracy. With the above-described treatment method, other materials may be admixed in addition to the active material, the organic molecular chain, and solvent, and in this case, too, the organic molecular chain can be chemically adsorbed onto the surface of active material.

With the treatment method in accordance with the present invention, in a case where the concentration of solids at the time of when the force required for kneading or the mixture temperature has reached a maximum magnitude is denoted by A1, and the concentration of solids in the kneading step is denoted by A2, it is preferred that the two concentrations satisfy the following Formula (3):

A1−10≦A2 (3)

With the above-described treatment method, the organic molecular chain can be reliably chemically adsorbed onto the surface of active material.

In the case where the concentration of solids A2 becomes less than (A1−10), the amount of solvent in the mixture becomes too high. Therefore, a large force cannot be applied to the mixture, and the organic molecular chain cannot be chemically adsorbed onto the surface of active material.

The present invention provides yet another method for treating an active material.

With this treatment method, no solvent is used. Thus, a mixture composed of an active material and at least one organic molecular chain is kneaded, and the organic molecular chain is chemically adsorbed onto the surface of active material.

With this treatment method, because only the active material and the organic molecular chain are kneaded, the admixture of impurities, etc., from other materials can be prevented, and these impurities can be prevented from being adsorbed onto the surface of active material. Because no impurities are adsorbed onto the surface of active material, the amount of organic molecular chains that can be chemically adsorbed onto the surface of active material can be increased.

With the treatment method in accordance with the present invention, the active material is preferably heated to a temperature of between 1000° C. and 1500° C. in a vacuum or an inert gas atmosphere prior to the kneading step.

With such a treatment method, impurities that adhere to the active material or functional groups that adhere to the surface of active material can be removed. The number of dangling-bond exposed on the surface of active material is increased and chemical adsorption of the organic molecular chain onto the surface of active material is facilitated. In the case where no heating is conducted in a vacuum or an inert gas atmosphere, for example, or the heating is performed in a typical air environment, the active material can be oxidized during heating. Further, even when the active material is heated to a temperature below 1000° C., the impurities that adhered to the active material or functional groups that adhered to the surface of active material sometimes cannot be removed. On the other hand, in the case where the active material is heated to a temperature higher than 1500° C., the crystal structure of an active material changes and the number of dangling-bond exposed on the surface of active material decreases. By heating the active material to a temperature of between 1000° C. and 1500° C., it is possible to remove impurities that adhered to the surface of active material or functional groups that adhered to the surface of active material, without decreasing the number of dangling-bond.

The present invention also provides a method for manufacturing a paste.

A step of adding a solvent and kneading is implemented continuously after any of the above-described methods for treating the active material has been conducted. Thus, a paste can be manufactured by adding a solvent to a mixture containing a treated active material in which at least one organic molecular chain has been chemically adsorbed onto the surface of active material, and then kneading is continuously performed. In addition to the solvent, other materials, for example, a binder can be also added after the active material has been treated.

The present invention also provides an apparatus for manufacturing a paste.

This manufacturing apparatus comprises a solvent supply device that supplies a solvent to a mixture containing an active material and at least one organic molecular chain; a device for kneading the mixture containing the active material, the organic molecular chain and solvent; a device for measuring a force required for kneading the mixture; and a control device that controls the solvent supply device so that the solvent from the solvent supply device is continuously supplied until the point in time is reached at which the force required for kneading the mixture is at a maximum magnitude; when the point in time is reached, the continuous supply of the solvent from the solvent supply device is stopped; and the predetermined amount of solvent is additionally supplied.

With the above-described manufacturing apparatus, a paste containing a treated active material, in which at least one organic molecular chain has been chemically adsorbed onto the surface of active material, can be manufactured. In order to stop the continuous supply of solvent at a point in time at which the force required for kneading the mixture is a maximum and to add the predetermined amount of solvent, a load applied to the device that kneads the mixture can be decreased. In a state in which the load applied to the device is small, the organic molecular chain can be chemically adsorbed onto the surface of active material. Other materials may be admixed in addition to the active material, the organic molecular chain, and solvent. Further, after the predetermined amount of solvent has been additionally supplied and kneading has been conducted for the predetermined time, the solvent can be added to adjust the viscosity of paste.

The present invention also provides another apparatus for manufacturing a paste.

This manufacturing apparatus comprises a solvent supply device that supplies a solvent to a mixture containing an active material and at least one organic molecular chain; a device for kneading the mixture containing the active material, the organic molecular chain, and solvent; a device for measuring a force required for kneading the mixture; and a control device that controls the solvent supply device so that the solvent is continuously supplied from the solvent supply device until the force required for kneading the mixture switches from a rising trend to a falling trend and decreases to a predetermined force.

With the above-described manufacturing apparatus, a paste containing a treated active material in which at least one organic molecular chain has been chemically adsorbed onto the surface of active material can also be manufactured. The predetermined force can be set to a force that enables the chemical adsorption of the organic molecular chain onto the surface of active material. In the above-described manufacturing apparatus, other materials may be admixed in addition to the active material, the organic molecular chain, and solvent. Further, the solvent can be further added to adjust the viscosity of the paste.

The present invention also provides another apparatus for manufacturing a paste.

This manufacturing apparatus comprises a solvent supply device that supplies a solvent to a mixture containing an active material and at least one organic molecular chain; a device for kneading the mixture containing the active material, the organic molecular chain and solvent; a device for measuring the temperature of the mixture; and a control device that controls the solvent supply device so that the solvent is continuously supplied from the solvent supply device until the mixture temperature switches from a rising trend to a falling trend and decreases to a predetermined temperature.

With the above-described manufacturing apparatus, a paste containing a treated active material in which at least one organic molecular chain has been chemically adsorbed onto the surface of active material can also be manufactured. The predetermined temperature can be set to a temperature that enables the chemical adsorption of the organic molecular chain onto the surface of active material. In the above-described manufacturing apparatus, other materials may be admixed in addition to the active material, the organic molecular chains, and solvent. Further, the solvent can be further added to adjust the viscosity of paste.

In accordance with the present invention, it is possible to obtain a treated active material in which at least one organic molecular chain is chemically adsorbed onto the surface of active material. A paste containing the treated active material can be also manufactured. A secondary battery using the treated active material can be manufactured. With the secondary battery using the treated active material, a charge-discharge characteristic can be maintained at a good level for a long period.

### BRIEF DESCRIPTION OF DRAWINGS

FIG. 1 illustrates schematically treated active material of the example.

FIG. 2 is a graph illustrating the relationship between a motor load and a concentration of solids in a mixture.

FIG. 3 is a graph illustrating the relationship between a motor load and a kneading time of a mixture.

FIG. 4 shows a paste manufacturing apparatus.

FIG. 5 is a flowchart of the process for manufacturing a paste in which a motor load is measured and a predetermined amount of solvent is added.

FIG. 6 is a flowchart of the process for manufacturing a paste in which a motor load is measured.

FIG. 7 is a flowchart of the process for manufacturing a paste in which a mixture temperature is measured.

FIG. 8 is an enlarged view of the active material surface before the heat treatment.

FIG. 9 is an enlarged view of the active material surface after the heat treatment.

FIG. 10 shows the state in which the organic molecular chain is chemically adsorbed on the active material.

### BEST MODE FOR CARRYING OUT THE INVENTION

The preferred embodiments of the present invention will be described below.

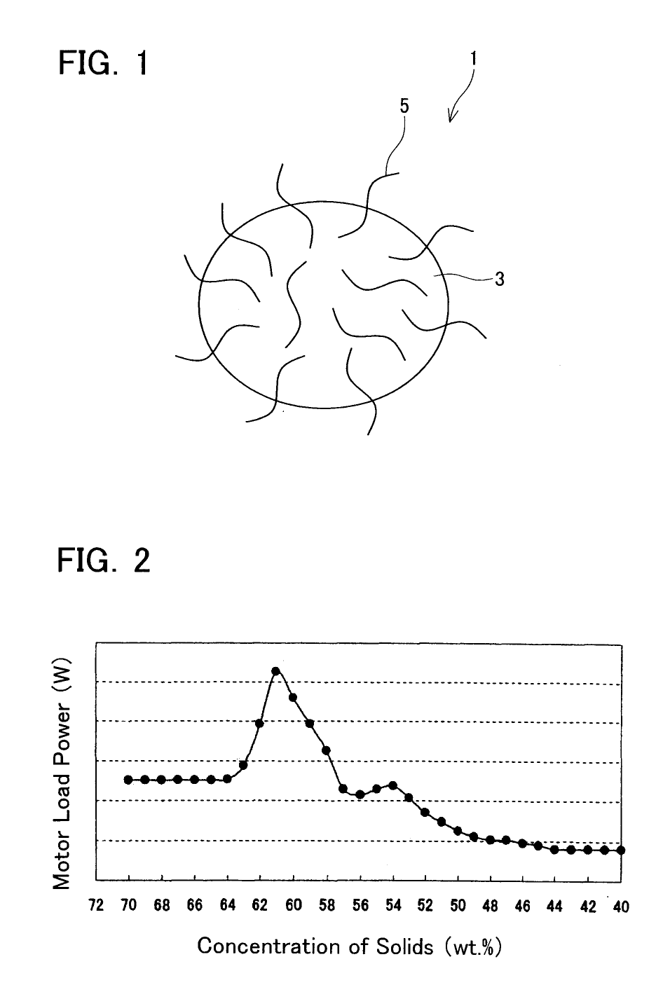

FIG. 1 shows schematically a treated active material 1 in which organic molecular chains 5 have been chemically adsorbed onto the surface of an active material 3. As described hereinbelow, the organic molecular chains 5 are chemically adsorbed onto dangling-bond on the surface of the active material 3. Thus, the active material 3 and organic molecular chains 5 are bonded by a force of 40-400 kJ/mol. Because the bonding force of the active material 3 and organic molecular chains 5 is strong, the active material 3 and organic molecular chains 5 are difficult to separate even when pressure or vibrations are applied to the treated active material 1. Further, the bonding force of the active material 3 and organic molecular chains 5 can be measured by IR (Infrared Spectroscopy) or by observing a thermal vibration pattern by TEM (Transmission Electron Microscopy) and performing calculations. Thus, it is possible to determine whether the organic molecular chains 5 have been chemically adsorbed onto the active material 3. The treated active material 1 can be distinguished from a system in which the active material 3 and organic molecular chains 5 are bonded by van der Waals forces.

The treated active material 1 can be used as an active material for electrodes of a secondary battery. When the treated active material 1 is used as an active material for a negative electrode, the active material 3 is preferably a carbon material, more preferably an amorphous carbon material. Examples of preferred materials include natural graphite, artificial graphite, and graphite coated with amorphous carbon. When the secondary battery is charged, lithium ions released from the positive electrode active material are absorbed into the negative electrode active material. Where the active material 3 is a carbon material, a large number of lithium ions can be absorbed.

In secondary batteries, a charge-discharge characteristic tends to deteriorate as the charge-discharge cycles are repeated. This phenomenon is caused by repeated expansion and contraction of the negative electrode active material and peeling of the active material from the surface of the negative electrode collector, occurring when the secondary battery is repeatedly charged and discharged. In the treated active material 1, the organic molecular chains 5 are chemically adsorbed onto the surface of active material 3. Therefore, the organic molecular chains 5 do not peel off from the collector surface when the negative electrode collector repeatedly expands and contracts. As a result, in a secondary battery using the treated active material 1 as a negative electrode active material, the deterioration of the charge-discharge characteristic is inhibited even in repeated charging and discharging.

The organic molecular chains 5 are preferably chain polymers, and preferred examples of suitable materials include polysaccharides (such as starch and cellulose), polyethylene, polyimides, polyamides, and phenolic resins.

When the treated active material 1 is used as an electrode active material, the treated active material 1 is coated on the collector surface. In this case, a binder is sometimes added to increase adhesion between the treated active material 1 and the collector surface. The SP value of the organic molecular chains 5 is preferably within a range of ±10 of the SP value of the binder, and it is especially preferred that the SP value of the organic molecular chains 5 be within a range of ±5 of the SP value of the binder. It is not always necessary to select the material of the organic molecular chains 5 with reference to the SP value of the binder. Thus, it is possible to take the SP value of the organic molecular chains 5 as a reference and select a binder that has an SP value within a range of ±10 of the SP value of the organic molecular chains 5. Substances with close SP values tend to be easily miscible. Thus, in the case where the SP value of the organic molecular chains 5 is within a range of ±10 of the SP value of the binder, the binder can be easily dispersed in the paste while the treated active material 1 and the binder are mixed. When the paste is coated on a collector surface, it is difficult for the treated active material 1 to peel off from the collector surface.

The binder is not particularly limited, provided that it is a material that can increase the adhesion of the treated active material 1 and the collector surface, but organic polymers are generally preferred. Thus rubbers are preferred, and the examples of especially preferred materials include styrene-butadiene rubbers (SBR), butyl rubber, butadiene rubber, and ethylene-propylene rubber. The binder can be appropriately selected according to the material of the organic molecular chains 5. For example, when the organic molecular chains 5 are carboxymethyl cellulose (CMC), an SBR is the preferred example of binder. The SP value of CMC is within a range of ±5 of the SP value of SBR.

A method for obtaining the treated active material 1 by treating the active material 3 will be described below.

The treated active material 1 can be obtained by causing chemical adsorption of the organic molecular chains 5 onto the surface of active material 3. In order to cause chemical adsorption of the organic molecular chains 5 onto the surface of active material 3, kneading has to be conducted by applying a strong force to a mixture containing the active material 3 and organic molecular chains 5. In the case where kneading is carried out by adding a solvent in an amount necessary to obtain a flowability for coating on a collector surface, the organic molecular chains 5 cannot be chemically adsorbed onto the surface of active material 3. Thus, an adequate amount of solvent has to add to the mixture of the two components in order to cause chemical adsorption of the organic molecular chains 5 onto the surface of active material 3. The two components can be kneaded to treat the active material 3 by a wet method (a method of kneading with the addition of a solvent to the mixture) or a dry method (a method of kneading without adding a solvent to the mixture). First, a wet treatment method will be described.

With a wet treatment method, the amount of solvent added to the mixture is controlled so that the organic molecular chains 5 are chemically adsorbed onto the surface of active material 3, that is, so that a force applied to the mixture of the two components is increased. Depending on a method for determining the amount of solvent added to the mixture, the following four wet treatment methods can be considered.

(a) A method by which the amount of solvent to be added is determined based on a tap density Dt of active material 3, true density Dr of active material 3, and density Ds of the solvent.

(b) A method by which a mixture containing the active material 3 and organic molecular chains 5 is prepared, the mixture is kneaded while a solvent is being added thereto, and a predetermined amount of solvent is added to the mixture at a timing at which the force required for kneading the mixture is at a maximum.

(c) A method by which a mixture containing the active material 3 and organic molecular chains 5 is prepared, the mixture is kneaded while a solvent is being added thereto, and the supply of solvent is stopped at the point in time at which the force required for kneading the mixture switches from a rising trend to a falling trend and decreases to a predetermined force.

(d) A method by which a mixture containing the active material 3 and organic molecular chains 5 is prepared, the mixture is kneaded while a solvent is being added thereto, and the supply of solvent is stopped at the point in time at which the mixture temperature switches from a rising trend to a falling trend and decreases to a predetermined temperature.

First, method (a) will be explained.

The tap density Dt of active material 3 is measured. The tap density Dt of active material 3 is measured according to a JIS standard. Thus, a density measured at a number of 500 taps with a device PT-N manufactured by Hosokawa Micron Co., Ltd. is measured as the tap density Dt.

A mixture containing the active material 3, organic molecular chains 5, and a solvent is kneaded under conditions such that the value N calculated by the following Formula (1)

N=100/(1+(1/Dt−1/Dr)×Ds) (1)

and the concentration of solids A in the mixture satisfy the following relationship (2)

N−10≦A≦N (2)

where Dt stands for a tap density of active material 3, Dr stands for a true density of active material 3, and Ds stands for a density of the solvent.

The organic molecular chains 5 are chemically adsorbed onto the surface of active material 3 by kneading the mixture with a kneading machine. The treated active material 1 can then be obtained by drying the mixture in a vacuum or an inert gas atmosphere.

Method (b) will be described below.

A mixture containing the active material 3 and organic molecular chains 5 is prepared. In this case, it is not necessary to measure the tap density of active material 3 or true density of active material 3. The mixture is then placed in a kneading machine, and a solvent is added to the mixture while the mixture is being kneaded. When the solvent is added to the mixture, a load on the kneading machine required to knead the mixture rises. FIG. 2 shows the relationship between load power applied to a motor of the kneading machine and the concentration of solids in the mixture when the solvent is added while the mixture containing the active material 3 and organic molecular chains 5 is being kneaded. Load power of a motor of the kneading machine is plotted along the vertical, and the concentration of solids in the mixture is plotted along the horizontal. Thus, in the example shown in FIG. 2, a force required for kneading the mixture is represented by load power of the motor. As shown by the curve in FIG. 2, when the solvent is added to the mixture (the point where the concentration of solids in the mixture decreases), the load power of the motor of the kneading machine changes. The load power applied to the motor is at maximum at a concentration of solids of about 61%. Thus, in the example shown in FIG. 2, the force required for kneading the mixture containing the active material 3 and organic molecular chains 5 is at the maximum when the concentration of solids in the mixture is 61% (this concentration of solids will be referred to hereinbelow as a maximum concentration of solids A1).

Kneading of the mixture can be continued at the maximum concentration of solids A1. However, in the case where the kneading is continued in a state with the maximum concentration of solids A1, the load applied to the kneading machine becomes too high. Accordingly, a predetermined amount of the solvent is further added to the mixture at the maximum concentration of solids A1. The amount of solvent is preferably such that the maximum concentration of solids A1 and the concentration of solids A2 (the concentration of solids in a mixture containing the active material 3, organic molecular chains 5, and the solvent) satisfy the following Formula (3)

A1−10≦A2 (3).

When the kneading is performed at a concentration of solids A2 that satisfies Formula (3), the organic molecular chains 5 can be reliably chemically adsorbed onto the surface of active material 3. The treated active material 1 can then be obtained by drying the mixture in a vacuum or an inert gas atmosphere.

Method (c) will be described below.

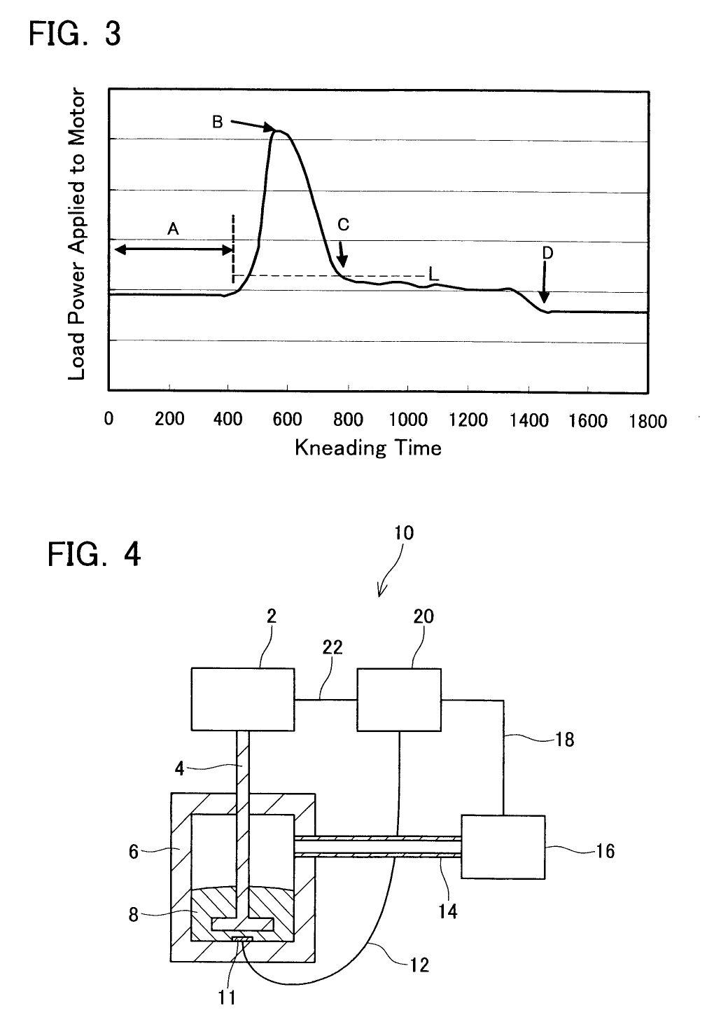

A mixture containing the active material 3 and organic molecular chains 5 is prepared. Then the mixture is placed into a kneading machine, and a solvent is added to the mixture while the mixture is being kneaded. FIG. 3 shows the relationship between load power applied to the motor of the kneading machine and kneading time when the solvent is added to the mixture containing the active material 3 and organic molecular chains 5 while the mixture is being kneaded. As shown in FIG. 3, when the solvent is added to the mixture, the load power (applied to the motor of the kneading machine) required to knead the mixture switches from a rising trend (between A and B) to a falling trend (between B and C). With the present treatment method, the supply of solvent to the mixture is stopped when the point in time (time C in FIG. 3) is reached, at which the force required for kneading the mixture decreases to a predetermined force L. By further kneading the mixture, it is possible to cause chemical adsorption of organic molecular chains 5 onto the surface of active material 3. The treated active material 1 can then be obtained by drying the mixture in a vacuum or an inert gas atmosphere.

Method (d) will be described below.

A mixture containing the active material 3 and organic molecular chains 5 is prepared. Then the mixture is placed into a kneading machine, and a solvent is added to the mixture while the mixture is being kneaded. FIG. 3 shows the relationship between the load power applied to the motor of the kneading machine and the kneading time; there is an almost proportional relationship between the load power applied to the motor of the kneading machine and mixture temperature. Thus, when the load for kneading the mixture tends to rise, the mixture temperature tends to rise; when the load for kneading the mixture tends to decrease, the mixture temperature tends to decrease. With the present treatment method, the supply of solvent to the mixture is stopped when the point in time (time C in FIG. 3) is reached, at which the mixture temperature switches from a rising trend to a falling trend and decreases to a predetermined temperature. By further kneading the mixture, it is possible to cause chemical adsorption of organic molecular chains 5 onto the surface of active material 3. The treated active material 1 can then be obtained by drying the mixture in a vacuum or an inert gas atmosphere.

In the treatment of the above-described methods (b) to (c), it is also preferred that Formula (3) above be satisfied; in the formula, A1 stands for a concentration of solids at the point in time the required kneading force or mixture temperature is at a maximum (time B in FIG. 3), and A2 stands for a concentration of solids in the kneading process.

By causing chemical adsorption of organic molecular chains 5 onto the surface of active material 3, and then kneading by adding a solvent without drying the mixture in the above described treatment methods (a) to (d), it is possible to manufacture a paste in which organic molecular chains 5 are chemically adsorbed onto the surface of active material 3. When the paste is manufactured, a mixture of the active material 3, organic molecular chains 5 and a binder may be prepared; and kneading may be performed while adding the solvent to the mixture. Further, the solvent and binder may be added at the same time after the organic molecular chains 5 have been chemically adsorbed onto the surface of active material 3. With certain kinds of binders, the bonding performance thereof can decrease during kneading. Accordingly, it is preferred that the solvent and binder be added at the same time after the organic molecular chains 5 have been chemically adsorbed onto the surface of active material 3. When manufacturing the paste, it is preferable that the organic molecular chains 5 having a SP value within a range of ±10 of the SP value of the binder be used.

The dry treatment method will be described below.

First, a mixture composed of the active material 3 and the organic molecular chains 5 is prepared. Then the mixture is placed into a kneading machine and the mixture is kneaded for a predetermined time. A ball mill or the like is preferred as the kneading machine. In the present treatment method, no solvent is added to improve flowability of the mixture. A mixture kneading time and a force applied to the mixture can be appropriately adjusted according to the material used. The kneading conditions may be determined by implementing kneading under a plurality of conditions corresponding to the materials used and implementing the above-described method of measuring the bonding force of the active material 3 and the organic molecular chains 5.

The advantages of obtaining the treated active material 1 by the dry treatment method are listed below.

(Advantage 1) Adsorption of impurities on the surface of active material 3 can be inhibited.

The dry method uses no solvent during kneading. Therefore, ions or impurities contained in the solvent can be prevented from adhering to the surface of active material 3. As a result, a large region where the organic molecular chains 5 can be chemically adsorbed onto the surface of active material 3 can be maintained.

(Advantage 2) A short manufacturing process.

A step of drying the kneaded mixture containing the active material 3 and organic molecular chains 5 in a vacuum or an inert gas atmosphere can be omitted. Further, it is possible to confirm whether the treated active material 1 is obtained immediately after the mixture has been kneaded.

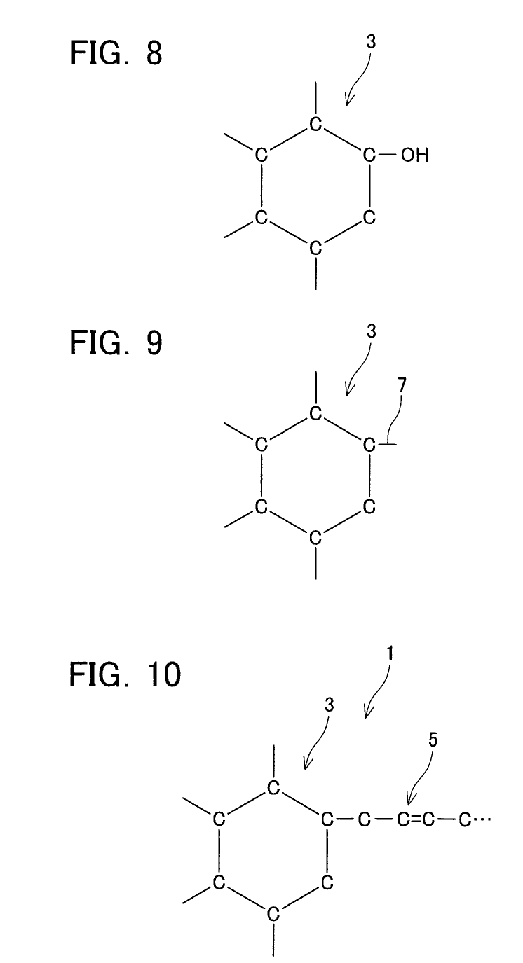

It is preferred that the active material 3 be heated to a temperature of between 1000° C. and 1500′C in a vacuum or an inert gas atmosphere before the organic molecular chains 5 are chemically adsorbed onto the surface of active material 3. FIG. 8 is an enlarged view of the surface of active material 3, active material 3 being a carbon material. As shown in FIG. 8, hydroxyl groups (—OH) have been adsorbed onto the active material 3. In this state, it is difficult for the organic molecular chains 5 to be chemically adsorbed to the surface of active material 3.

FIG. 9 shows the active material obtained by heating the active material 3 (shown in FIG. 8) for 2 hours in an argon (Ar) atmosphere at 1100° C. As follows from FIG. 9, the hydroxyl groups that have been adsorbed onto the active material 3 are removed and dangling-bond 7 is generated in the active material 3. FIG. 10 shows a state in which the organic molecular chain 5 is chemically adsorbed onto the surface of the active material 3. The organic molecular chain 5 is chemically adsorbed by the dangling-bond 7 of active material 3.

An apparatus for manufacturing a paste will be explained.

An apparatus 10 for manufacturing a paste is described below and with reference to FIG. 4. The manufacturing apparatus 10 comprises a container 6 for accommodating a mixture 8 containing the active material 3 and organic molecular chains 5; a solvent supply device 16 that supplies a solvent to the mixture 8; a stirring blade 4 that kneads the mixture 8; and a control device 20 that controls the solvent supply device 16. The stirring blade 4 is connected to a motor 2, and a unit for measuring load power required to operate the stirring blade 4 is disposed inside the motor 2. The solvent supply device 16 can supply the solvent into the container 6 via a solvent supply pipe 14. The motor 2 and control device 20 are connected by a signal line 22, and the load power of the motor 2 can be inputted to the control device 20. The solvent supply device 16 and control device 20 are connected by a signal line 18, and the amount of solvent supplied from the solvent supply device 16 to the container 6 can be adjusted. A thermocouple 11 is disposed inside the container 6, and the temperature of the mixture 8 can be measured. The temperature measured by the thermocouple 11 can be inputted via the signal line 12 to the control device 20.

The manufacturing device 10 includes three control methods for determining the amount of solvent supplied to the container 6. With one control method, the solvent is supplied from the solvent supply device 16 into the container 6 until the point in time at which the force required for kneading the mixture 8 is at a maximum, and the continuous supply of solvent from the solvent supply device 16 is stopped at the point in time at which the force required for kneading the mixture 8 is at a maximum. The control device 20 stops the continuous supply of solvent from the solvent supply device 16 and supplies a predetermined amount of solvent into the container 6.

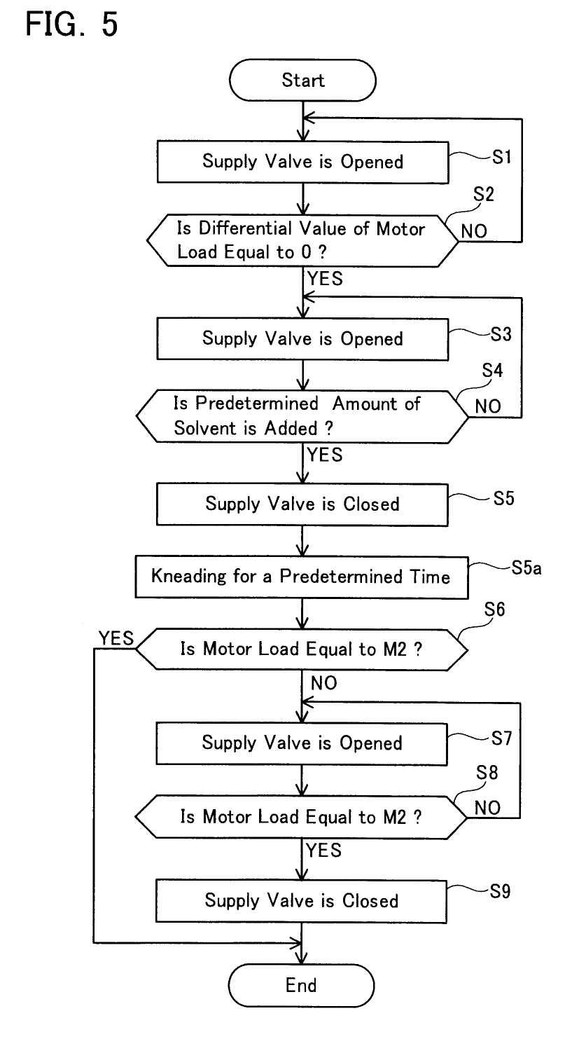

The paste manufacturing process generally involves a step of supplying a solvent until the point in time at which the load of motor 2 has a maximum, a step of chemically adsorbing the organic molecular chains 5 onto the surface of active material 3, and a step of adjusting the paste viscosity. FIG. 5 shows a flowchart relating to kneading in the present control method.

First, the mixture 8 is accommodated inside the container 6, and the motor 2 is then turned on and the stirring blade 4 is actuated while monitoring the load power applied to the motor 2. Then, a supply valve of the solvent supply device 16 is opened (S1). The power load of motor 2 does not change before the amount of solvent in the mixture 8 reaches a predetermined value (state A in FIG. 3). At the point in time at which the force required for kneading the mixture 8 reaches maximum, the value obtained by differentiating the load power of motor 2 by time becomes 0 (state B in FIG. 3). Thus, the point in time, at which the value obtained by differentiating the load power of motor 2 by time is 0, is a time at which the force required for kneading the mixture 8 reaches maximum. When the value obtained by differentiating the load power of motor 2 by time is determined to be 0 (S2: YES), the supply valve is opened and the predetermined amount of solvent (S3) is added. Then, in the case where the amount of the solvent added to the mixture 8 is detected to be the predetermined value (S4: YES), the supply valve of the solvent supply device 16 is closed (S5). The solvent is continuously supplied to the mixture 8 as long as the differentiated value of the load of motor 2 is not determined to be 0 (S2: NO).

In the case where the predetermined amount of solvent is added to the mixture 8, the load of motor 2 decreases (state C in FIG. 3). In this state, the mixture 8 is kneaded for a predetermined time (S5a) and the organic molecular chains 5 are chemically adsorbed onto the surface of active material 3. The amount of solvent added to the mixture 8 in step S2 is stored in a memory and this concentration of solids in the mixture 8 is taken as A1. The concentration of solids in the mixture 8 at the time the predetermined amount of solvent is added to the mixture 8 in step S4 is taken as A2. In this case, it is preferred that the predetermined amount of solvent be calculated and the predetermined amount of solvent be added to the mixture 8 so that the concentration of solids A1 and concentration of solids A2 be within ranges satisfying Formula (3).

Then, it is detected whether the load of motor 2 is a predetermined value M2 (S6). In the case where the load of motor 2 has not reached the predetermined value M2 (S6: NO), the supply valve of the solvent supply device 16 is opened (S7). The predetermined value M2 is set to a force that is less than the motor load immediately after step S5a has been implemented and that will knead the paste when the solvent is added to obtain flowability suitable for coating on a collector. In the case where the load of motor 2 decreases to the predetermined value M2 (S8: YES), the supply valve of the solvent supply device 16 is closed (S9). Then, the paste can be manufactured by kneading the mixture 8 for a predetermined time. In the case where the load of motor 2 is not detected to have reached the predetermined value M2 (S8: NO), the supply valve of the solvent supply device 16 is continuously open. Further, when the load of motor is decreased to the predetermined value M2 in step S6 by adding a binder or solvent after the mixture 8 has been kneaded for a predetermined time (S6: YES), the operation ends. The viscosity of paste can be set to a desired value by changing the predetermined value to M2.

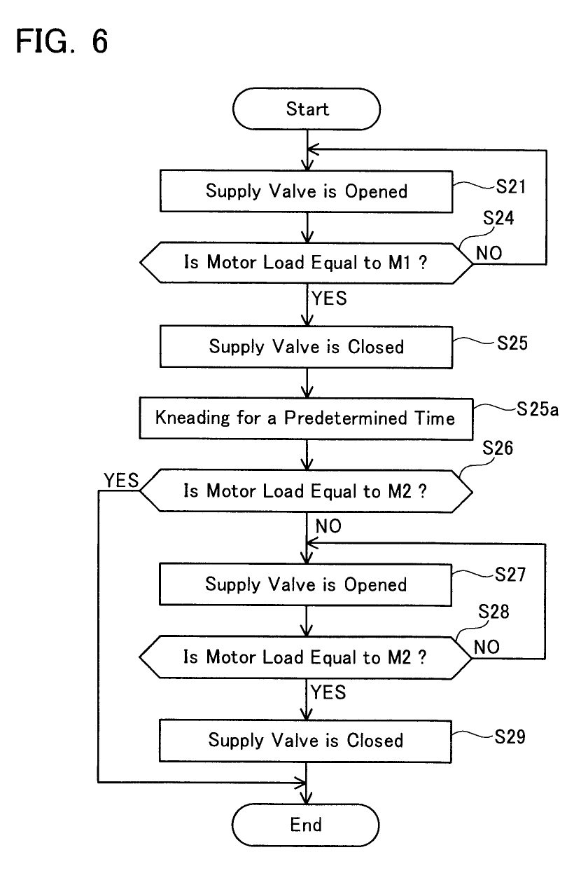

With another method for controlling the manufacturing apparatus 10, the solvent is supplied from the solvent supply device 16 until the force required for kneading the mixture 8 switches from the rising trend to the falling trend and decreases to a predetermined value. FIG. 6 shows a flowchart relating to kneading in the present control method.

First, the mixture 8 is accommodated inside the container 6, and the motor 2 is then turned on and the stirring blade 4 is actuated while monitoring the load power applied to the motor 2. Then, a supply valve of the solvent supply device 16 is opened (S21). In the case where the load of motor 2 is detected to switch from the rising trend to the falling trend and decrease to a predetermined force M1 (a state of transition from A to C in FIG. 3; S24: YES), the supply valve of the solvent supply device 16 is closed (S25). In the case where the predetermined force M1 is not detected (S24: NO), the supply valve of the solvent supply device 16 is continuously open. In this state, the mixture 8 is kneaded for a predetermined time (s25a), and the organic molecular chains 5 are chemically adsorbed onto the surface of active material 3. Subsequent steps are identical to those explained with reference to the flowchart shown in FIG. 5 and explanation thereof is herein omitted. In the steps substantially identical to those of the flowchart shown in FIG. 5, the same step number is added to the last digit in FIG. 6. In the present control method, the conditions are set to satisfy the relationship M1>M2.

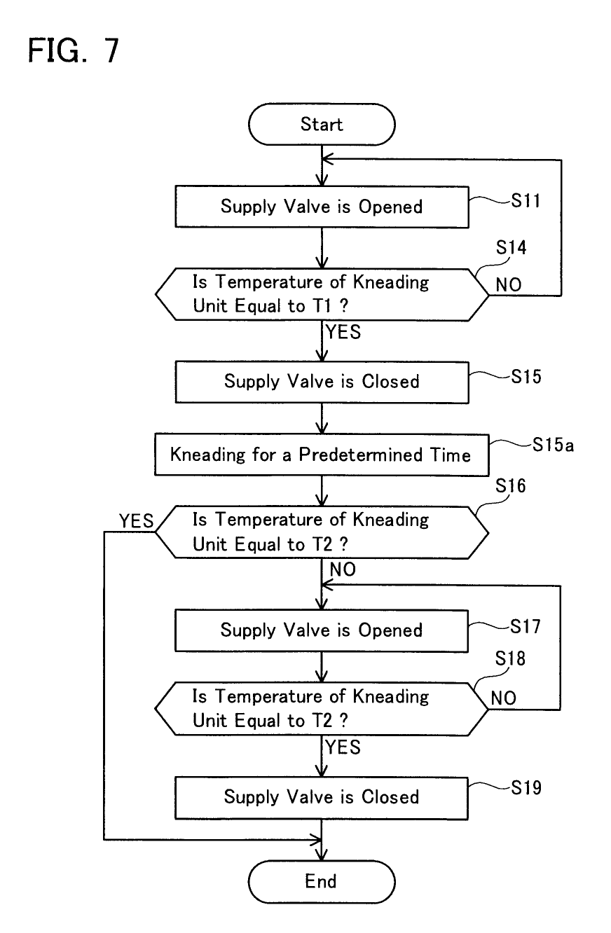

With yet another method for controlling the manufacturing apparatus 10, the solvent is supplied from the solvent supply device 16 until the temperature of mixture 8 switches from the rising trend to the falling trend and decreases to a predetermined temperature. FIG. 7 shows a flowchart relating to kneading in the present control method.

First, the mixture 8 is accommodated inside the container 6, and the motor 2 is then turned on and the stirring blade 4 is actuated while monitoring the temperature of the mixture 8 by the control device 20. Then, a supply valve of the solvent supply device 16 is opened (S11). In the case where the temperature of mixture 8 is detected to switch from the rising trend to the falling trend and decrease to a predetermined temperature T1 (S14: YES), the supply valve of the solvent supply device 16 is closed (S15). In the case where the predetermined temperature T1 is not detected (S14: NO), the supply valve of the solvent supply device 16 is continuously open. In this state, the mixture 8 is kneaded for a predetermined time (s15a), and the organic molecular chains 5 are chemically adsorbed onto the surface of active material 3.

Then, it is determined whether the temperature of mixture 8 is a predetermined temperature T2 (S16). In the case where the temperature of mixture 8 has not decreased to the predetermined temperature T2 (S16: NO), the supply valve of the solvent supply device 16 is opened again (S17). In the case where the temperature of mixture 8 is detected to have decreased to the predetermined temperature T2 (S18: YES), the supply valve of the solvent supply device 16 is closed (S19). Then, the paste can be manufactured by kneading the mixture 8 for a predetermined time. In the case where the temperature of mixture 8 is not detected to have decreased to the predetermined temperature T2 (S18: NO), the supply valve of the solvent supply device 16 is continuously open. Further, in the case where the temperature of mixture 8 has decreased to the predetermined temperature T2 in step S16 (S16: YES), the operation ends. Here, T1>T2, and T2 is set to a temperature of mixture 8 at the time the mixture 8 is kneaded by adding the solvent to obtain a flowability necessary for the paste.

### EXAMPLES

Examples will be explained below.

In the examples, the manufacture of a secondary battery using the treated active material 1 shown in FIG. 1 as a negative electrode active material will be explained.

### First Example

A method for manufacturing a secondary battery of the present example will be explained. First, a method for manufacturing a positive electrode will be explained.

A total of 93 parts by weight of lithium cobalt oxide, 5 parts by weight of graphite, 1 part by weight of polytetrafluoroethylene (PTFE), and 1 part by weight of carboxymethyl cellulose (CMC) are weighed and a mixture is prepared. A total of 100 parts by weight of water is added to the mixture and a positive electrode paste is produced. Then, an aluminum foil (collector) with a thickness of 10 μm is prepared, the positive electrode paste is coated on both surfaces thereof, and the positive electrode paste is then dried to complete the fabrication of the positive electrode. The positive electrode has a rectangular shape with a length in the longitudinal direction of 1.9 m.

A method for manufacturing a negative electrode will be described below.

A total of 500 g of natural graphite (active material) 3 with a tap density of 0.94 g/cc and a true density of 2.20 g/cc, 5 g of CMC (organic molecular chain) 5, and 333 g of water are weighed to prepare a mixture 8. The mixture 8 is kneaded for 30 minutes at 50 revolutions per minute by using a two-shaft planetary kneading machine 10 with a diameter of 200 mm. The mixture 8 of the present example satisfies Formula (2) above. Thus, the concentration of solids A in the mixture 8 is 60 wt. %, the value N obtained by substituting the physical properties of natural graphite 3 into Formula (1) is 62 wt. %, and the condition (N−10≦A≦N) is satisfied.

The obtained mixture 8 is then dried for 3 hours in a nitrogen (N₂) atmosphere at 120° C. At this stage, CMC 5 is chemically adsorbed onto the surface of natural graphite 3.

Then, a mixture is prepared by weighing 98 parts by weight of the treated natural graphite (treated active material) 1, 1 part by weight of CMC, and 1 part by weight of SBR. A negative electrode paste is fabricated by adding 100 parts by weight of water to the mixture. A copper (Cu) foil (collector) with a thickness of 10 μm is then prepared, the negative electrode paste is coated on both surfaces thereof, and the negative electrode paste is dried to complete the fabrication of the negative electrode. The negative electrode has a rectangular shape with a length in the longitudinal direction of 2.1 m.

A polypropylene (PP) film with a thickness of 30 μm is then prepared, the positive electrode and negative electrode are disposed opposite each other via the PP film, and a wound body is fabricated using a winding machine. The PP film has a rectangular shape with a length in the longitudinal direction of 2.1 m. The wound body is collapsed in the direction perpendicular to the winding axis, a positive electrode terminal is connected to the positive electrode, and a negative electrode terminal is connected to the negative electrode. The wound body and an electrolytic solution are then accommodated in a container and the container is sealed to manufacture a secondary battery. The solvent of the electrolytic solution was a mixture containing ethylene carbonate (EC) and dimethyl carbonate (DMC) at a volume ratio of 1:1. LiPF₆ was used as a solute of the electrolytic solution and the solute was mixed with the solvent at 1 mol/L. The amount of electrolytic solution contained in the container was 50 mL.

An electric capacity retention ratio was measured for the secondary battery of the present example. A method for measuring the electric capacity retention ratio will be described below.

An operation of changing the SOC (State Of Charge: charging depth related to the battery capacity) of the secondary battery from 0% to 100% is taken as 1 cycle, and 1000 cycles of such operation are implemented. Charging and discharging of the secondary battery were performed at 2C (C: amount of electricity that can be fully charged within 1 hour). The electric capacity retention ratio was measured at 25° C.

The electric capacity retention ratio represents a ratio of electric capacity in the thousandth cycle of charging and discharging to electric capacity in the third cycle of charging and discharging. The results are shown in Table 1.

TABLE 1

| | Concentration | |
|---|---|---|
| | of solids during | Capacity |
| | kneading (wt. %) | retention ratio (%) |
| Example 1 | 60 | 80.5 |
| Example 2 (A) | 61 | 85 |
| Example 2 (B) | 56 | 86 |
| Example 2 (C) | 51 | 85 |
| Example 4 | 60 | 80 |
| Comparative Example 1 | — | 78.7 |
| Comparative Example 2 (D) | 65 | 70 |
| Comparative Example 2 (E) | 46 | 70 |

### Second Example

The configuration of the secondary battery of the present example is identical to that of the first example, except that the method for manufacturing the negative electrode active material is different. Here, only the difference from the first example will be explained and the explanation of features identical to those of the first example will be omitted.

A mixture 8 is prepared by weighing 500 g of natural graphite 3 having physical properties identical to those in the first example, 5 g of CMC 5, and 12.5 g of SBR (concentration of solids 40%). The mixture 8 is kneaded at a speed of 50 revolutions per minute by using a two-shaft planetary kneading machine 10 with a diameter of 200 mm while adding water in 10 mL increments to the mixture 8. The relationship between the concentration of solids in the mixture 8 and the load power applied to the motor 2 of the two-shaft planetary kneading machine 10 was measured. The results are shown in FIG. 2. In the graph shown in FIG. 2, the load power applied to the motor 2 is plotted against the vertical, and the concentration of solids in the mixture 8 is plotted on the horizontal. As shown in FIG. 2, the concentration of solids at which the load power of motor 2 had a maximum was found to be 61%.

In the present example, a plurality of mixtures 8 was prepared by using 500 g of natural graphite 3 having physical properties identical to those in the first example, 5 g of CMC 5, and 12.5 g of SBR. Mixtures 8 with a concentration of solids of 3 types denoted by (A) to (C) below were prepared by varying the amount of water added to the mixture 8. In Comparison Example 2, mixtures 9 with a concentration of solids of 2 types denoted by (D), (E) below were prepared.

(A) Concentration of solids 61%.

(B) Concentration of solids 56%.

(C) Concentration of solids 51%.

(D) Concentration of solids 65%.

(E) Concentration of solids 46%.

The mixtures 8 with a concentration of solids of (A)-(E) types were kneaded at a speed of 50 revolutions per minute by using a two-shaft planetary kneading machine 10 having a diameter of 200 mm and pastes were manufactured by further adding a predetermined amount of water.

The electric capacity retention ratio was measured for the secondary battery of the present example by the same method as in the first example. The results are shown in Table 1.

### Third Example

The secondary battery of the present example has the same configuration as that of the second example, except that the method for determining the amount of water added to the mixture 8 is different. Only the difference between this example and second example will be explained below, and the explanation of features identical to those of the second example will be omitted.

A mixture 8 was prepared by weighing 500 g of natural graphite 3 having a tap density of 0.94 g/cc and a true density of 2.20 g/cc, 5 g of CMC 5, and 12.5 g of SBR. The relationship between the concentration of solids in the mixture 8 and the temperature of mixture 8 was measured while adding water to the mixture 8. The results demonstrated that the concentration of solids at which the temperature of mixture 8 reached a maximum was 61%. It was also confirmed that the concentration of solids at which the load power applied to the motor 2 in the second example is equal to the concentration of solids at which the temperature of mixture 8 is at a maximum.

### Fourth Example

The secondary battery of the present example has the same configuration as that of the first example, except that the method for manufacturing the negative electrode active material is different. Only the difference between this example and first example will be explained below, and the explanation of features identical to those of the first example will be omitted.

A mixture 8 was prepared by weighing 500 g of natural graphite 3 having physical properties identical to those of the first example and 5 g of CMC 5. The mixture 8 was kneaded for 150 minutes at a speed of 120 revolutions per minute by using a ball mill in a nitrogen atmosphere (inert gas atmosphere) at usual temperature (25° C.). The ball mill had a cylindrical container with an inner diameter of 50 mm, and the balls had a size of 5 mm. A secondary battery was then manufactured by the same method as in the first example. In the present example, the mixing of natural graphite and CMC and then a step of drying the mixture 8 before the negative electrode paste is manufactured have been omitted. The results obtained in measuring the electric capacity retention ratio are shown in Table 1.

### Fifth Example

The secondary battery of the present example has the same configuration as that of the first example, except that the method for manufacturing the negative electrode active material is different. Only the difference between this example and first example will be explained below, and the explanation of features identical to those of the first example will be omitted.

In accordance with the present invention, natural graphite was heat treated in an inert gas atmosphere prior to kneading the natural graphite and CMC. Thus, a secondary battery identical to that of the first example was manufactured by heating 500 g of natural graphite for 2 hours in an argon (Ar) atmosphere and using 500 g of the heat-treated natural graphite. The natural graphite was heat treated under two temperatures: (F) 1100° C. and (G) 1400° C. In Comparison Example 3, the secondary batteries were also manufactured by heat treating natural graphite at a temperature of (H) 800° C. and (I) 1700° C.

The electric capacity retention ratio was measured for the obtained secondary batteries in the same manner as in the first example. The results are shown in Table 2.

TABLE 2

| | Heating | Capacity |
|---|---|---|
| | temperature (° C.) | retention ratio (%) |
| Example 5 (F) | 1100 | 80.4 |
| Example 5 (G) | 1400 | 81.4 |
| Comparative Example 3 (H) | 800 | 82.2 |
| Comparative Example 3 (I) | 1700 | 77.1 |

### Comparative Example 1

The secondary battery of the present comparative example has a configuration identical to that of the first example, except that the method for manufacturing a negative electrode active material is different. A negative electrode paste was fabricated by mixing 98 parts by weight of natural graphite having physical properties identical to those of the first example, 1 part by weight of CMC, and 1 part by weight of SBR. No kneading machine or the like was used during mixing. Subsequent processes are identical to those of the first example. The results obtained in measuring the electric capacity retention ratio are shown in Table 1.

In the secondary battery of the first example, the capacity retention ratio is higher than that of the secondary battery of comparative example 1. Thus, the capacity retention ratio of a secondary battery can be increased when the relationship between the value N (calculated from Formula (1) derived from the tap density of active material (carbon material), the true density of active material, and the density of solvent) and concentration of solids A (during kneading of the active material, the organic molecular chain (CMC), and solvent) satisfies the relationship N−10≦A≦N. Thus, it has been shown that the active material does not peel off from the negative electrode even in long-term repeated charging and discharging. This phenomenon indicates that the organic molecular chain has been chemically adsorbed onto the surface of active material.

As clearly follows from (A) to (C) of the second example, when the mixture 8 of active material 3 and the organic molecular chains 5 is kneaded, the organic molecular chains 5 can be chemically adsorbed onto the surface of active material 3 in the case where the concentration of solids A1 at the time the force applied to the mixture 8 is at maximum and the concentration of solids A2 at the time the mixture containing the active material 3 and organic molecular chains 5 is kneaded satisfy the relationship A1−10≦A2. As shown in Comparative Example 2 (E), where the relationship A1−10≦A2 is not satisfied, the capacity retention ratio of the secondary battery decreases. This result can be explained as follows. Because the organic molecular chains 5 have not been chemically adsorbed onto the surface of active material 3, the active material 3 peels off from the collector surface in repeated charging and discharging. Further, the concentration of solids A1 at the time the force applied to the mixture 8 is at maximum is equal to the value N. Thus, the second example (A) to (C) and Comparative Example 2 (D), (E) demonstrate that the capacity retention ratio of the secondary battery can be increased when the relationship between the value N (derived from the tap density of carbon material (active material), true density of carbon material, the solvent density) and the concentration of solids A (when the carbon material, the organic molecular chain, and solvent are kneaded) satisfy the relationship N−10≦A≦N.

In the secondary battery of the fourth example, the capacity retention ratio is higher than that of the secondary battery of Comparative Example 1. Thus, it has been shown that the organic molecular chains 5 can be chemically adsorbed onto the surface of active material 3 by kneading the mixture 8 composed of the active material (carbon material) 3 and the organic molecular chains (CMC) 5.

As clearly shown in Table 2, the capacity retention ratio can be increased by implementing heat treatment at a temperature of between 1000° C. and 1500° C. before the organic molecular chains 5 are chemically adsorbed onto the surface of active material 3. The capacity retention ratio of Example 5 (F), (G) has increased by comparison with that of Example 1. Thus, this result indicates that a large number of organic molecular chains 5 have been chemically adsorbed onto the surface of active material 3. The capacity retention ratio of Comparative Example 3 (H) is almost identical to that of Example 1. This result indicates that the amount of organic molecular chains 5 adsorbed onto the surface of active material 3 does not increase when the active material 3 is subjected to heat treatment at a temperature lower than 1000° C. In Comparative Example 3 (I), the capacity retention ratio decreased with respect to that of Example 1. This phenomenon indicates that the number of dangling-bond 7 for chemically adsorbing the organic molecular chain onto the surface of active material 3 has decreased due to crystallization of active material 3.

Specific examples of the present invention are described above, but these are merely illustrating examples that place no limitation on the scope of patent claims. The technique described in the patent claims also includes a variety of changes and modifications of the above-described specific examples.

Further, technical elements explained in the detailed description of the invention or the drawings demonstrate technical utility individually or in various combinations thereof and are not limited to the combinations described in the patent application at the time of filing. Further, the technique illustrated by way of examples in the detailed description of the invention or drawings can attain a plurality of objects at the same time, and technical utility is demonstrated by merely attaining one object therefrom.

1. A treated electrode active material in which at least one organic molecular chain is chemically adsorbed onto a surface of active material.

2. A paste containing the treated electrode active material in claim 1, containing an electrode active material, a solvent, a binder, and at least one organic molecular chain having an SP value within a range of ±10 with respect to an SP value of the binder, wherein at least one organic molecular chain is chemically adsorbed onto a surface of electrode active material.

3. A secondary battery containing the treated electrode active material in claim 1.

4. A method for manufacturing the treated electrode active material in claim 1, comprising:
treating an electrode active material, wherein a mixture containing the electrode active material, at least one organic molecular chain, and a solvent is kneaded under conditions such that a value N calculated by the following Formula (1):
N=100/(1+(1/Dt−1/Dr)×Ds) (1)
and a concentration of solids A in the mixture satisfy the following relationship (2):
N−10≦A≦N (2)
where Dt stands for a tap density of the electrode active material, Dr stands for a true density of the electrode active material, and Ds stands for a density of the solvent.

5. A method for manufacturing the treated electrode active material in claim 1, comprising the steps of:
kneading a mixture containing the electrode active material and at least one organic molecular chain, while continuously adding a solvent, and detecting a point in time, at which a force required for kneading the mixture has reached a maximum magnitude; and
adding a predetermined amount of solvent to the mixture at the point in time, and further kneading the mixture.

6. A method for manufacturing the treated electrode active material in claim 1, comprising the steps of:
kneading a mixture containing the electrode active material and at least one organic molecular chain, while continuously adding a solvent, and detecting the arrival of a point in time, at which a force required for kneading the mixture switches from a rising trend to a falling trend and decreases to a predetermined force; and
stopping the supply of the solvent when the reaching of the point in time is detected, and further kneading the mixture.

7. A method for manufacturing the treated electrode active material in claim 1, comprising the steps of:
kneading a mixture containing the electrode active material and at least one organic molecular chain, while continuously adding a solvent, and detecting the reaching of a point in time, at which the temperature of the mixture during kneading switches from a rising trend to a falling trend and decreases to a predetermined temperature; and
stopping the supply of solvent when the reaching of the point in time is detected, and further kneading the mixture.

8. A method for manufacturing the treated electrode active material according to claim 5, wherein the following Formula (3) is satisfied:
A1−10≦A2 (3)
where A1 is a concentration of solids at the point in time the force required for kneading or the mixture temperature has reached the maximum magnitude and A2 is a concentration of solids in the kneading step.

9. A method for manufacturing the treated electrode in claim 1, wherein a mixture composed of the electrode active material and at least one organic molecular chain is kneaded and the organic molecular chain is chemically adsorbed onto a surface of electrode active material.

10. A method for manufacturing the treated electrode active material according to claim 4, wherein the electrode active material is heated to a temperature of between 1000° C. and 1500° C. in a vacuum or an inert gas atmosphere prior to the kneading step.

11. A method for manufacturing a paste containing a treated electrode active material in which at least one organic molecular chain is chemically adsorbed onto a surface of active material, in which a step of adding a solvent and kneading is performed continuously after the method for manufacturing the treated active material according to claim 4 has been implemented.

12. An apparatus for manufacturing the paste in claim 2, comprising:
a solvent supply device that supplies a solvent to a mixture containing the electrode active material and at least one organic molecular chain;
a device for kneading the mixture containing the electrode active material, at least one organic molecular chain, and solvent;
a device for measuring a force required for kneading the mixture; and
a control device that controls the solvent supply device so that the solvent from the solvent supply device is continuously supplied until the arrival of the point in time, at which the force required for kneading the mixture is at a maximum magnitude, and when the timing, at which the force required for kneading the mixture is at the maximum magnitude, is reached, the continuous supply of the solvent from the solvent supply device is stopped, and the predetermined amount of solvent is additionally supplied.

13. An apparatus for manufacturing the paste in claim 2, comprising:
a solvent supply device that supplies a solvent to a mixture containing the electrode active material and at least one organic molecular chain;
a device for kneading the mixture containing the electrode active material, at least one organic molecular chain, and solvent;
a device for measuring a force required for kneading the mixture; and
a control device that controls the solvent supply device so that the solvent is continuously supplied from the solvent supply device until the force required for kneading the mixture switches from a rising trend to a falling trend and decreases to a predetermined force.

14. An apparatus for manufacturing the paste in claim 2, comprising:
a solvent supply device that supplies a solvent to a mixture containing the electrode active material and at least one organic molecular chain;
a device for kneading the mixture containing the electrode active material, at least one organic molecular chain, and solvent;
a device for measuring a temperature of the mixture; and
a control device that controls the solvent supply device so that the solvent is continuously supplied from the solvent supply device until the mixture temperature switches from a rising trend to a falling trend and decreases to a predetermined temperature.
